(19) United States
(12) Patent Application Publication
(10) Pub. No.: US 2013/0295915 A1
(43) Pub. Date: Nov. 7, 2013

(54) Network Nodes and Methods Configured for Updating Neighbor Cell Information in a Radio Communications System Comprising at Least One Radio Access Technology Network

(71) Applicants: Masatoshi Nakamata, Kawasaki (JP); Krzysztof Kordybach, Pulawy (PL)

(72) Inventors: Masatoshi Nakamata, Kawasaki (JP); Krzysztof Kordybach, Pulawy (PL)

(73) Assignee: Nokia Siemens Networks Oy, Espoo (FI)

(21) Appl. No.: 13/814,777

(22) PCT Filed: Aug. 8, 2011
(86) PCT No.: PCT/EP2011/063615

§ 371 Date: Apr. 8, 2013

(30) Foreign Application Priority Data
Aug. 8, 2010 (EP) PCT/EP2010/061562

(51) Int. Cl. H04W 36/00

(52) U.S. Cl. CPC H04W 36/0061
USPC 455/422.1

(57) ABSTRACT

The present invention refers to network nodes and methods being configured for updating neighbor cell information in a radio communications system including at least one Radio Access Technology network. The radio communications system includes a mobile terminal, a first network node controlling a first cell, a second network node controlling a second cell, the first network node broadcasting a first neighbor cell list, and the second network node broadcasting a second neighbor cell list. The method includes the steps of receiving, by the second network node from the mobile terminal, an indicator, with the indicator indicating a missing neighbor cell relation entry in the first neighbor cell list, the neighbor cell relation entry representing a neighbor cell relation between the first cell and the second cell; and sending, from the second network node to the first network node, a cell identifier, the cell identifier uniquely identifying the second cell, and first cell-specific information technically characterizing the second cell, the first cell-specific information permitting updating the first neighbor cell list, with the missing neighbor cell relation entry.

Network nodes and methods configured for updating neighbor cell information in a radio communications system comprising at least one Radio Access Technology network

### FIELD OF THE INVENTION

The present invention relates to updating neighbor cell information in a radio communications system comprising at least one Radio Access Technology network. Particularly, the present invention refers to methods configured for said updating neighbor cell information; and network nodes configured to perform said updating neighbor cell information.

### BACKGROUND OF THE INVENTION

In cell-based radio communications systems, the concept of Automatic Neighboring Relation (ANR) is known. Conventionally, the operator of a cell-based radio communications system has to keep record of Neighbor Relations (NR) of neighbor cells spanned by radio base stations manually for the purpose of handing over calls to neighboring cells, which is a tedious and error-prone task. Furthermore, NR information has to be changed frequently due to network modifications, i.e. addition or removal of radio base stations.

ANR, as agreed within the 3rd generation partnership project (3GPP), allows for an improved process of keeping neighbor cell information up to date by automatically updating neighbor cell relations.

For a cell controlled by a Radio Network Controller (RNC), ANR involves a Neighbor Relation Table (NRT), managed by the RNC. The NRT is used for keeping information related to neighboring cells up to date.

The scope of ANR functionality was specifically agreed for UMTS Terrestrial Radio Access (UTRA) systems, as well as generally for any Radio Access Technology (RAT). With regard to UTRA, ANR functionality covers intra-UTRA relations, i.e. intra-Radio Network Subsystem (RNS) and inter-RNS relations. With regard to general RATs, inter-RAT relations are covered, i.e. source cell being UMTS Terrestrial Radio Access Network (UTRAN) and target cell being GSM/EDGE Radio Access Network (GERAN), or source cell being UTRAN and target cell being Evolved UTRAN (E-UTRAN).

There have been proposals on user equipment (UE) assistance for the RNC to identify missing Neighbor Relations, involving reports by the UE to the RNC, relating to missing NRs.

However, this would, amongst others, involve a considerable increase of signaling load on the air-interface.

Thus, there is still a need for an improved procedure for updating neighbor cell information.

### SUMMARY OF THE INVENTION

Object of the present invention is improving of updating neighbor cell information in a radio communications system comprising at least one Radio Access Technology network.

This object is achieved by methods comprising features according to claims 1 and 3, and network nodes comprising features according to claims 5 and 7.

Further embodiments of the present invention are provided with the corresponding dependent claims.

The object of the present invention is achieved by a method, said method being configured for updating neighbor cell information in a radio communications system comprising at least one Radio Access Technology network. The radio communications system comprises a mobile terminal, a first network node controlling a first cell, a second network node controlling a second cell, the first network node broadcasting a first neighbor cell list, and the second network node broadcasting a second neighbor cell list. The method comprises the steps of
receiving, by the second network node from the mobile terminal, an indicator, with the indicator indicating a missing neighbor cell relation entry in the first neighbor cell list, the neighbor cell relation entry representing a neighbor cell relation between the first cell and the second cell; and
sending, from the second network node to the first network node, a cell identifier, the cell identifier uniquely identifying the second cell, and first cell-specific information technically characterizing the second cell, the first cell-specific information permitting updating the first neighbor cell list with the missing neighbor cell relation entry.

The invention provides an improved procedure for updating neighbor cell information.

According to embodiments of the present invention, the method further comprises the steps of receiving, by the second network node from the first network node, second cell-specific information technically characterizing the first cell, the second cell-specific information permitting updating the second neighbor cell list with the missing neighbor cell relation entry; and updating, by the second network node, the second neighbor cell list with the missing neighbor cell relation entry, using the second cell-specific information.

This allows for a symmetric updating of neighbor cell information in both network nodes involved.

The object of the present invention is also achieved by a method, said method being configured for updating neighbor cell information in a radio communications system comprising at least one Radio Access Technology network, said radio communications system comprising a mobile terminal, a first network node controlling a first cell, a second network node controlling a second cell, the first network node broadcasting a first neighbor cell list, and the second network node broadcasting a second neighbor cell list. The method comprises the steps of
receiving, by the first network node from the second network node, a cell identifier, the cell identifier uniquely identifying the second cell,
   and first cell-specific information technically characterizing the second cell, the first cell-specific information permitting updating the first neighbor cell list with a missing neighbor cell relation entry in the first neighbor cell list, the neighbor cell relation entry representing a neighbor cell relation between the first cell and the second cell; and
updating, by the first network node, the first neighbor cell list with the missing neighbor cell relation entry, using the first cell-specific information.

The invention provides an improved procedure for updating neighbor cell information.

According to embodiments of the present invention, the method further comprises the steps of sending, from the first network node to the second network node, second cell-specific information technically characterizing the first cell, the second cell-specific information permitting updating the second neighbor cell list with the missing neighbor cell relation entry.

This allows for a symmetric updating of neighbor cell information in both network nodes involved.

The object of the present invention is also achieved by a network node configured for updating neighbor cell information in a radio communications system comprising at least one Radio Access Technology network, the network node controlling a cell, said radio communications system further comprising a mobile terminal, a further network node controlling a further cell, the further network node broadcasting a first neighbor cell list, and the network node broadcasting a second neighbor cell list. The network node comprises
receiving means configured for receiving, from the mobile terminal, an indicator, with the indicator indicating a missing neighbor cell relation entry in the first neighbor cell list, the neighbor cell relation entry representing a neighbor cell relation between the cell and the further cell;
sending means configured for sending, to the further network node, a cell identifier, the cell identifier uniquely identifying the cell, and first cell-specific information technically characterizing the cell, the first cell-specific information permitting updating the first neighbor cell list with the missing neighbor cell relation entry.

The invention provides an improved procedure for updating neighbor cell information.

According to further embodiments of the present invention, said network node further comprises second receiving means, configured for receiving, from the further network node, second cell-specific information technically characterizing the further cell, the second cell-specific information permitting updating the second neighbor cell list with the missing neighbor cell relation entry; and updating means configured for updating the second neighbor cell list with the missing neighbor cell relation entry, using the second cell-specific information.

This allows for a symmetric updating of neighbor cell information in both network nodes involved.

The object of the present invention is also achieved by a network node configured for updating neighbor cell information in a radio communications system comprising at least one Radio Access Technology network, the network node controlling a first cell, said radio communications system comprising a mobile terminal, a second network node controlling a second cell, the network node broadcasting a first neighbor cell list, and the second network node (12) broadcasting a second neighbor cell list. The network node comprises
receiving means configured for receiving, from the second network node, a cell identifier, the cell identifier uniquely identifying the second cell,
   and first cell-specific information technically characterizing the second cell, the first cell-specific information permitting updating the first neighbor cell list with a missing neighbor cell relation entry in the first neighbor cell list, the neighbor cell relation entry representing a neighbor cell relation between the first cell and the second cell; and
updating means configured for updating the first neighbor cell list with the missing neighbor cell relation entry, using the first cell-specific information.

The invention provides an improved procedure for updating neighbor cell information.

According to further embodiments of the present invention, said network node further comprises sending means configured for sending, to the second network node, second cell-specific information technically characterizing the first cell, the second cell-specific information permitting updating the second neighbor cell list with the missing neighbor cell relation entry.

This allows for a symmetric updating of neighbor cell information in both network nodes involved.

According to some embodiments of the present invention, the first network node and the second network node are part of the same Radio Network Subsystem of a Radio Access Technology network.

This allows for Inter-RNS ANR, where ANR information for cells belongs to different RNCs.

According to some embodiments of the present invention, the first network node is part of a first Radio Access Technology network with a first Radio Access Technology, and the second network node is part of a second Radio Access Technology network with a second Radio Access Technology, said first and second Radio Access Technologies being different.

This allows for Inter-RAT ANR, where ANR information is exchanged between different RATs.

According to some embodiments of the present invention, the first Radio Access Technology is UTRAN and the second Radio Access Technology is GERAN, or the first Radio Access Technology is GERAN and the second Radio Access Technology is UTRAN.

This allows for Inter-RAT ANR, where ANR information is exchanged between different RATs, in particular between UTRAN and GERAN.

According to some embodiments of the present invention, the first Radio Access Technology is UTRAN and the second Radio Access Technology is E-UTRAN, or the first Radio Access Technology is E-UTRAN and the second Radio Access Technology is UTRAN.

This allows for Inter-RAT ANR, where ANR information is exchanged between different RATs, in particular between UTRAN and E-UTRAN.

### BRIEF DESCRIPTION OF THE DRAWINGS

The present invention will be more clearly understood from the following description of the preferred embodiments of the invention read in conjunction with the attached drawings, in which:

FIG. 1 shows a radio communications network according to some embodiments of the present invention.

FIG. 2 shows an implementation of the present invention according to some embodiments of the present invention.

FIG. 3 shows an implementation of the present invention according to some embodiments of the present invention.

### DESCRIPTION OF THE PREFERRED EMBODIMENTS

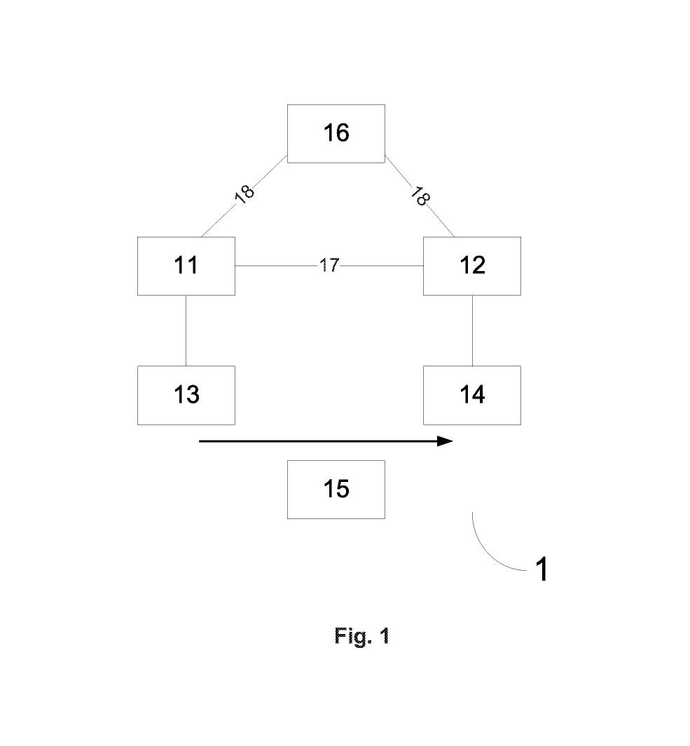

FIG. 1 shows a radio communications network according to some embodiments of the present invention.

The radio communications system 1 comprises a mobile terminal 15, a first network node 11 controlling a first cell 13, and a second network node 12 controlling a second cell 14. The first network node 11 broadcasts a first neighbor cell list, and the second network node 12 broadcasts a second neighbor cell list.

The first RNC 11, which is the RNC controlling the source cell 13, and the second RNC 12, which is the RNC controlling the target cell 14, are connected by an Iur interface 17. Furthermore, the first RNC 11 and the second RNC 12 are connected with each other by an Iu interface 18 via the core network 16.

The Iu interface is specified in 3GPP TS 25.410 and is the interface between the core network and the UMTS radio access network. It is divided into two layers. The bottom layer is the transport network layer. The top layer is the radio network layer. The Iu interface is vertically divided into planes, the user plane and the control plane. The control plane of the radio network layer consists of the radio access network application part (RANAP). The RANAP as specified in 3GPP TS 25.413 is the radio network signaling protocol of the Iu interface. It consists of mechanisms to handle all procedures between core network and the UMTS radio access network.

The logical interface between any two RNCs is called Iur interface and is specified in 3GPP TS 25.420. It is divided into two layers. The bottom layer is the transport network layer. The top layer is the radio network layer. The Iur interface is vertically divided into planes, the user plane and the control plane. The control plane of the radio network layer consists of the radio access network subsystem application part (RNSAP). The RNSAP as specified in 3GPP TS 25.423 is the radio network signaling protocol of the Iur interface. It consists of mechanisms to handle all procedures between two RNCs.

According to some embodiments, the first network node 11 and the second network 12 nodes are Radio Network Controllers of an UTRAN network. In these cases, the first cell 13 and the second cell 14 are spanned by radio base stations (not shown in FIG. 1).

According to further embodiments, the first network node 11 is a Base Station Controller of a GERAN network or an Evolved NodeB of E-UTRAN network and the second network node is a Radio Network Controller of an UTRAN network.

The situation depicted in FIG. 1 shows the mobile terminal 15 switching, or being switched, from the first cell 13 to the second cell 14. This switching corresponds to cell reselection from a source cell 13 to a target cell 14 and is indicated by the arrow in FIG. 1 and following figures.

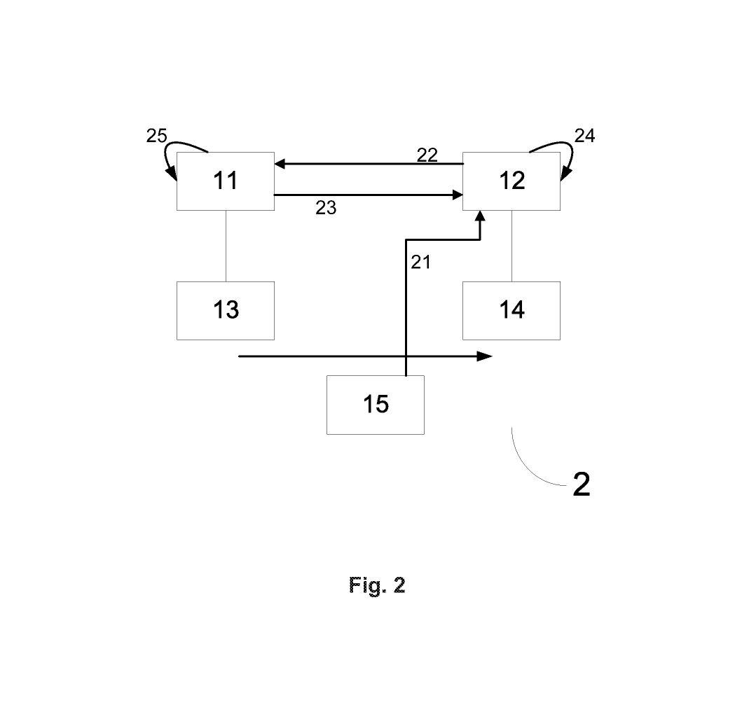

FIG. 2 shows an implementation of the present invention according to some embodiments of the present invention.

In the following, the steps of the method are described from the perspective of the second network node 12.

In a receiving step 21, the second network node 12 receives an indicator from the mobile terminal 15. The indicator indicates a missing neighbor cell relation entry in the first neighbor cell list, the neighbor cell relation entry representing a neighbor cell relation between the first cell 13 and the second cell 14.

In other words, upon cell reselection from the source cell 13 to the target cell 14 by the mobile terminal 15, the mobile terminal detects the target cell 14 not being in the first neighbor cell list, which is the neighbor cell list of the first network node 11, and therefore indicates this to the second network node 12.

In a sending step 22, the second network node 12 signals to the first network node 11 a cell identifier. This cell identifier uniquely identifies the second cell 14.

However, the cell identifier, which in some embodiments corresponds to the UTRAN Cell Identifier (UC-ID), is not sufficient for setting up a neighbor cell relation entry in the first neighbor cell list of the first network node 11.

Therefore, in the sending step 22, additional information is signaled from the second network node 12 to the first network node 11, the addition information being first cell-specific information technically characterizing the second cell 14. This first cell-specific information permits an updating of the first neighbor cell list with the missing neighbor cell relation entry.

According to further embodiments of the invention, in a receiving step 23, the second network node 12 receives, from the first network node 11, second cell-specific information technically characterizing the first cell 13. This second cell-specific information permits an updating of the second neighbor cell list with the missing neighbor cell relation entry, i.e. the neighbor cell list of the second network node 12.

In an updating step 24, the second network node 12 updates the second neighbor cell list with the missing neighbor cell relation entry, using the second cell-specific information.

This allows for a symmetric updating of neighbor cell information in both network nodes involved.

In the following, the steps of the method are described from the perspective of the first network node 11.

In a receiving step 22, the first network node 11 receives, from the second network node 12, a cell identifier. As said above, the cell identifier uniquely identifies the second cell 14.

However, as said above, the cell identifier, which in some embodiments corresponds to the UC-ID, is not sufficient for setting up a neighbor cell relation entry in the first neighbor cell list of the first network node 11.

Therefore, in the receiving step 22, additional information is received from the second network node 12, the addition information being first cell-specific information technically characterizing the second cell 14. This first cell-specific information permits updating the first neighbor cell list with a missing neighbor cell relation entry in the first neighbor cell list, the neighbor cell relation entry representing a neighbor cell relation between the first cell 13 and the second cell 14.

In an updating step 25, the first network node 11 updates the first neighbor cell list with the missing neighbor cell relation entry, using the first cell-specific information.

According to further embodiments of the invention, in a sending step 23, the first network node 11 sends, to the second network node 12, second cell-specific information technically characterizing the first cell 13. Similar as described above, the second cell-specific information permits an updating of the second neighbor cell list with the missing neighbor cell relation entry.

It has to be noted that the description of the steps above should not be understood to be limited to the sequence of the disclosed embodiments. It should be apparent that also other sequences of the steps of sending, receiving, and updating might be advantageous.

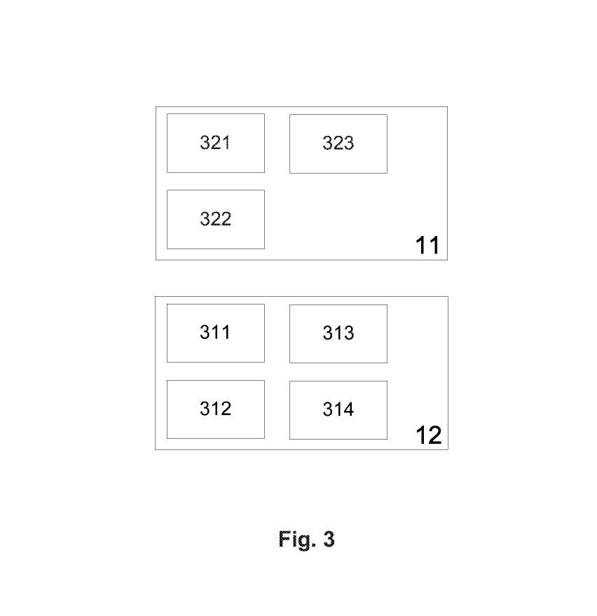

FIG. 3 shows an embodiment of the first network node 11 according to the invention. The first network node 11 comprises receiving means 321 configured for receiving, from the second network node 12, a cell identifier, the cell identifier uniquely identifying the second cell 14, and first cell-specific information technically characterizing the second cell 14. The first cell-specific information permits an updating of the first neighbor cell list with a missing neighbor cell relation entry in the first neighbor cell list, the neighbor cell relation entry representing a neighbor cell relation between the first cell 13 and the second cell 14.

The first network node 11 further comprises updating means 322 configured for updating the first neighbor cell list with the missing neighbor cell relation entry, using the first cell-specific information.

In further embodiments, the first network node 11 further comprises sending means 323 configured for sending, to the second network node 12, second cell-specific information technically characterizing the first cell 13, the second cell-specific information permitting updating the second neighbor cell list with the missing neighbor cell relation entry.

FIG. 3 also shows an embodiment of the second network node 12 according to the invention. The second network node 12 comprises receiving means 311, configured for receiving, from the mobile terminal 15, an indicator, with the indicator indicating a missing neighbor cell relation entry in the first neighbor cell list, the neighbor cell relation entry representing a neighbor cell relation between the first cell 13 and the second cell 14.

The second network node 12 further comprises sending means 312 configured for sending, from the second network node 12 to the first network node 11, a cell identifier, the cell identifier uniquely identifying the second cell 14, and first cell-specific information technically characterizing the second cell 14, the first cell-specific information permitting updating the first neighbor cell list with the missing neighbor cell relation entry.

In further embodiments of the invention, the second network node 12 further comprises second receiving means 313, configured for receiving, from the first network node 11, second cell-specific information technically characterizing the first cell 13, the second cell-specific information permitting updating the second neighbor cell list with the missing neighbor cell relation entry.

The second network node 12 further comprises updating means 314 configured for updating the second neighbor cell list with the missing neighbor cell relation entry, using the second cell-specific information.

In some embodiments of the invention, an Iur/Iu procedure is used to enable exchanging the ANR information in inter-RNC and inter-RAT scenarios, which is described in more detail in the following.

According to some embodiments of the invention, the procedure is bi-directional:

In a first step 21, the UE 15 triggers an “unknown cell” event. Then, the cell, or the RNC resp., that detects the missing relation uses the information reported from the UE 15 to fetch all the needed ANR data. At the same time it provides the data needed in the neighbor cell to set up the symmetrical relation.

Some advantages of the invention are that there is no need to introduce new ANR specific parameters into the involved Radio Resource Control (RRC) System Information Blocks (SIB), no need to send extra RRC message and, additionally, symmetry of the newly added neighbor relation is enabled with regard to the first and second network nodes 11, 12.

In the following, Inter-RNS scenario and Inter-RAT scenarios are described with references to FIG. 1 and FIG. 2. RNC_A will be used to refer to the first RNC 11, RNC_B will be used to refer to the second RNC 12.

### 1) Inter-RNS ANR:

In this scenario, ANR information for cells belongs to different RNCs.

1-1) Report from UE in Cell_FACH/PCH:

Step1) In a first step 21, the RNC_B 12 (Drift RNC, DRNC) receives the Cell Update message including the 1 bit information, which indicates that the UE executes the cell reselection to the second cell 14 (Cell_b, target cell) which is not listed in the neighboring list of the first cell 13 (Cell_a, source cell), and further indicates that the source cell 13 is not under the RNC_B 12.

In a second step 22, the RNC_B 12 includes cell-specific information for the second cell 14 under the RNC_B into a message signaled via the Iur interface 17 using the Radio Network Subsystem Application Part (RNSAP) protocol. The message is called “Uplink Signaling Transfer Indication message”, comprising the above mentioned “Cell Update message” and is forwarded to the RNC_A 11 (Serving RNC, SRNC) over Iur interface 17.

The cell-specific information technically characterizes the second cell 14, permitting the updating the first neighbor cell list with the missing neighbor cell relation entry. As the cell identifier alone is not sufficient to technically characterize a cell, it is necessary to provide this further, cell-specific information. Otherwise, the first RNC 11 would not be able to update the first neighbor cell list with the missing neighbor cell relation entry.

The cell-specific information is signaled using the RNSAP and is comprised in an Information element.

Step2) In a further step 22, the RNC_A 11 receives the Cell Update message in the RNSAP: UL Signaling Transfer Indication over Iur 17 with the cell-specific information for the second cell 14, and if the second cell 14 (Cell_b) under the RNC_B 12 is not registered as a neighboring cell of the source cell 13 (Cell_a) under the RNC_A 11, the RNC_A 11 adds, in a further step 25, the second cell 14 (Cell_b) into the neighboring cell list of the source cell 13 (Cell_a), using information (PSC and UARFCN) associated to the selected cell (Cell_b) which were contained in the RNSAP: Uplink Signaling Transfer Indication message, i.e. comprised in the cell-specific information. Furthermore, the RNC_A 11 informs the Operation & Maintenance (O&M) about the update.

Step3) The RNC_A's 11 behavior for updating the neighboring list for the selected cell 14 (Cell_b) under RNC_B 12 by adding the source cell 13 (Cell_a) in RNC_A 11 depends on the following Iu/Iur operation (implementation dependent) after reception of the Cell Update message:
Initiation of SRNS Relocation:

In a sending step 23, RNC_A 11 includes some cell-specific info (Cell ID, PSC, UARFCN, RRC Cell ID, LAC, RAC and Cell Capability, etc.) for source cell 13 (Cell_a) under RNC_A 11 into Source RNC to Target RNC Transparent Container in RANAP: Relocation Required message which is sent over the Iu interface 18. After the RNC_B 12 received the info in RANAP: Relocation Request message over Iu interface 18, RNC_B 12 updates, in an updating step 24, the neighboring cell list for the selected cell 14 (Cell_b) by adding the received info.
Initiation of Enhanced SRNS Relocation:

In a sending step 23, RNC_A 11 includes some cell-specific info (PLMN ID, Cell ID, PSC, UARFCN, RRC Cell ID, LAC, RAC and Cell Capability etc.) for source cell 13 (Cell_a) under the RNC_A 11 in the RNSAP: Enhanced Relocation Request message sent to RNC_B 12 over Iur interface 17. After the RNC_B 12 received the info in RNSAP: Enhanced Relocation Request message over Iur interface 17, the RNC_B 12 updates, in an updating step 24, the neighboring cell list for the selected cell 14 (Cell_b) by adding the received info.
Sending DCCH: Cell Update Confirm:

In a sending step 23, RNC_A 11 includes some cell-specific info (PLMN ID, Cell ID, PSC, UARFCN, RRC Cell ID, LAC, RAC and Cell Capability etc.) for source cell 13 (Cell_a) under the RNC_A 11 in RNSAP: Common Transport Channel Resources Request message sent to RNC_B 12 over Iur interface 17. After the RNC_B 12 received the info in the RNSAP message over Iur interface 17, the RNC_B 12 updates, in an updating step 24, the neighboring cell list for the selected cell 14 (Cell_b) by adding the received info.
Sending CCCH: Cell Update Confirm:

In a sending step 23, RNC_A 11 includes some cell-specific info (PLMN ID, Cell ID, PSC, UARFCN, RRC Cell ID, LAC, RAC and Cell Capability etc.) for source cell 13 (Cell_a) under the RNC_A 11 in RNSAP: Downlink Signalling Transfer Request message sent to RNC_B 12 over Iur interface 17. After the RNC_B 12 received the info in the RNSAP message over Iur interface 17, the RNC_B 12 updates, in an updating step 24, the neighboring cell list for the selected cell 14 (Cell_b) by adding the received info.

In some further embodiments of the invention, alternatively, since the O&M is informed by RNC_A 11 about the need for the update, O&M updates the neighboring cell list of the selected cell 14 (Cell_b) under RNC_B 12 to add info for source cell 13 (Cell_a).

Step2, as described above, enables RNC_B 12 to carry all necessary information for an update of the NCL to RNC_A 11 using the RNSAP message so that it is not required that the UE provides additional information in SIB to RNC_A 11 by an extra RRC message (e.g. UTRAN Mobility Information Confirm). This means that there is no need to introduce the proposed ANR specific parameters, i.e. the cell-specific information comprised in an Information Element and transmitted over the Iur interface 17, into the SIB, thereby reducing the signaling load on the air-interface in case of inter-RNS or inter-RAT cell reselection.

Step3) as described above enables RNC_A 11 to provide all necessary information for an update of the NCL of the second cell 14 under RNC_B so that it is possible to update the NCL of Cell_A 13 and Cell_B 14 in both nodes, RNC_A 11 and RNC_B 12, symmetrically and within one overall ANR update procedure.

In addition, the invention also works in case of different values assigned to UC-ID (RNC-ID +Cell ID) and RRC Cell Identity.

1-2) Report from UE in Idle:

In case the RNC_B 12 receives the RRC Connection Request message including the 1 bit information (or cause value) which indicates that UE 15 camps on the second cell 14 (Cell_B under RNC_B 12) which is not listed in neighboring list of the source cell 13 (Cell_A under RNC_A 11), or that UE 15 camps on the second cell 14 (Cell_B under RNC_B 12) with the neighboring list of the second cell 14 not listing the source cell 13 (Cell_A under RNC_A 11), the RNC_B 12 requests the UE 15 to report information of source cell 13 (Cell_A) and to update the neighboring cell list of Cell_B by adding the info for Cell_A and inform O&M about the update.

In case the RNC_B 12 needs to execute the Handover (HO) from Cell_B 14 to Cell_A 13 for the UE 15, the RNC_B 12 includes some cell-specific info (PLMN ID, Cell ID, PSC, UARFCN, RRC Cell ID, LAC, RAC and Cell Capability etc.) for Cell_B 14 into the following relevant messages for updating neighboring cell list of Cell_A 13 by adding Cell_B 14 associated info:
RNSAP: Radio Link Setup Request message
RNSAP: Common Transport Channel Resources Request message
RANAP: Source RNC to Target RNC Transparent Container

Alternatively, O&M updates a neighboring cell list of Cell_A 13 by adding Cell_B 14 associated info in RNC_A 11.

### 2) Inter-RAT ANR: UTRA ⇄ GERAN

In this scenario, ANR information is exchanged between different RATs, in particular between UTRAN and GERAN:

In case the RNC receives the RRC Connection Request message including the 1 bit information (or cause value) which indicates that the UE camps on the cell (Cell B) which is not listed in neighboring list of the source GERAN (Cell_A), or that UE 15 camps on the second cell 14 (Cell_B under RNC_B 12) with the neighboring list of the second cell 14 not listing the source cell 13 (Cell_A under RNC_A 11), the RNC requests the UE to report information for source GERAN cell (Cell_A) and update the neighboring cell list of Cell_B by adding the info for Cell_A in the RNC and inform the update to O&M.

In case the RNC needs to execute the HO from Cell_B to Cell_A for the UE, the RNC includes some cell-specific info (PLMN ID, LAI, RAC, RNC-ID (Extended RNC-ID) and C-ID, RRC Cell ID etc.) for Cell_B into the BSSGP: Source BSS to Target BSS Transparent Container to be forwarded to BSC via CN (BSSGP: base station system GPRS protocol).

Alternatively, O&M updates a neighboring cell list of Cell_A by adding Cell_B associated info in the Base station controller (BSC).

### 3) Inter-RAT ANR: UTRAN ⇄ E-UTRAN:

In this scenario, ANR information is exchanged between different RATs, in particular between UTRAN and E-UTRAN:

In case the RNC receives the RRC Connection Request message including the 1 bit information (or cause value) which indicates that the UE camps on the cell (Cell_B) which is not listed in neighboring list of the source E-UTRAN (Cell_A), the RNC requests the UE to report information for source E-UTRAN cell (Cell_A) and update the neighboring cell list of Cell_B by adding the info for Cell_A in the RNC.

In case the RNC needs to execute the HO from Cell_B to Cell_A for the UE, the RNC includes some cell-specific info (PLMN ID, LAI, RAC, RNC-ID (Extended RNC-ID) and C-ID, RRC Cell ID etc.) for Cell_B into the S1AP: Source eNB to Target eNB Transparent Container (RANAP: Source to Target Transparent Container) to be forwarded to the eNB via CN.

Alternatively, O&M updates a neighboring cell list of Cell_A by adding Cell_B and associated info in the eNB.

In addition, since the eNB is able to detect the missing neighboring relation between the E-UTRAN Cell and UTRAN cell, in case eNB needs to execute the HO from the E-UTRAN cell to detected UTRAN Cell, for updating the neighboring cell list of the UTRAN cell by adding the E-UTRAN cell, the eNB includes some cell-specific info (E-CGI, eNB ID and TAI etc.) in RANAP: Target RNC to Source RNC Transparent Container for the E-UTRAN cell.

In the following, the above mentioned Information Element comprising the cell-specific information is described in more detail.

In case of Inter-RNS ANR, the Information Element comprises the following information in RNSAP/RANAP:
Public Land Mobile Network (PLMN) Identity
UTRAN Cell Identifier (UC-ID)
Primary Scrambling Code (PSC)

Uplink (UL) UTRA Absolute RF Channel Number (UARFCN)
Downlink (DL) UARFCN
RRC Cell ID
Local Area Code (LAC)
Routing Area Code (RAC)
Cell Capability Container (Frequency Division Duplex (FDD), Time Division Duplex (TDD), TDD Low Chip Rate (LCR))
Cell Capability Container Extension FDD.

In case of Inter-RAT ANR, UTRAN ⇄ GERAN, the Information Element comprises the same information as for Inter-RNS ANR, however the Information Element is carried in a RANAP message.

In case of Inter-RAT ANR, UTRAN ⇄ E-UTRAN, the Information Element comprises the same information as for Inter-RNS ANR, however the Information Element is carried in a RANAP message. In addition, for the UTRAN ⇄ E-UTRAN case, the Information Element comprises:
E-UTRAN Cell Global Identity (CGI) (PLMN ID+Cell ID)
E-UTRA frequencies
Measurement Bandwidth
Tracking Area Code (TAC)

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. Therefore, it is intended that the foregoing detailed description should be regarded as illustrative rather than limiting.

### LIST OF ABBREVIATIONS

3GPP 3rd generation partnership project
ANR Automatic Neighboring Relation
BSC Base station controller
BSSGP Base station system GPRS protocol
CGI Cell Global Identity
DL Downlink
DRNC Drift RNC
E-UTRAN Evolved UTRAN
FDD Frequency Division Duplex
GERAN GSM/EDGE Radio Access Network
GPRS General Packet Radio Service
HO Handover
LAC Local Area Code
LTE Long Term Evolution
NR Neighbor Relation
NRT Neighbor Relation Table
O&M Operation & Maintenance
PLMN Public Land Mobile Network
PLMN ID Public Land Mobile Network Identity
PSC Primary Scrambling Code
RAC Routing Area Code
RANAP Radio Access Network Application Part
RAT Radio Access Technology
RNC Radio Network Controller
RNS Radio Network Subsystem
RNSAP Radio Access Network Subsystem Application Part
RRC Radio Resource Control
SIB System Information Block
SRNC Serving RNC
TAC Tracking Area Code
TDD Time Division Duplex
UE User Equipment
UL Uplink
UARFCN UTRA Absolute RF Channel Number
UMTS Universal Mobile Telecommunications System
UTRA UMTS Terrestrial Radio Access
UTRAN UMTS Terrestrial Radio Access Network
UC-ID UTRAN Cell Identifier

### LIST OF REFERENCES

1 radio communications system
11 first network node
12 second network node
13 first cell
14 second cell
15 mobile terminal
2 method
21 step of receiving an indicator
22 step of sending/receiving a cell identifier and cell-specific information
23 step of receiving/sending cell-specific information
24 step of updating a neighbor cell list
25 step of updating a neighbor cell list
311 receiving means
312 sending means
313 sending means
314 updating means
321 receiving means
322 updating means
323 sending means

1. A method configured for updating neighbor cell information in a radio communications system comprising at least one Radio Access Technology network, said radio communications system comprising a mobile terminal, a first network node controlling a first cell, a second network node controlling a second cell. the first network node broadcasting a first neighbor cell list, and the second network node broadcasting a second neighbor cell list,
the method comprising the steps of
receiving, by the second network node from the mobile terminal, an indicator, with the indicator indicating a missing neighbor cell relation entry in the first neighbor cell list, the neighbor cell relation entry representing a neighbor cell relation between the first cell and the second cell; and
sending, from the second network node to the first network node, a cell identifier, the cell identifier uniquely identifying the second cell, and first cell-specific information technically characterizing the second cell, the first cell-specific information permitting updating the first neighbor cell list with the missing neighbor cell relation entry.

2. Method according to claim 1, the method further comprising the steps of
receiving, by the second network node from the first network node, second cell-specific information technically characterizing the first cell, the second cell-specific information permitting updating the second neighbor cell list with the missing neighbor cell relation entry; and
updating, by the second network node, the second neighbor cell list with the missing neighbor cell relation entry, using the second cell-specific information.

3. A method configured for updating neighbor cell information in a radio communications system comprising at least one Radio Access Technology network, said radio communications system comprising a mobile terminal, a first network node controlling a first cell, a second network node controlling a second cell, the first network node broadcasting a first neighbor cell list, and the second network node broadcasting a second neighbor cell list,
the method comprising the steps of
receiving, by the first network node from the second network node, a cell identifier, the cell identifier uniquely identifying the second cell, and first cell-specific information technically characterizing the second cell, the first cell-specific information permitting updating the first neighbor cell list with a missing neighbor cell relation entry in the first neighbor cell list, the neighbor cell relation entry representing a neighbor cell relation between the first cell and the second cell; and
updating, by the first network node, the first neighbor cell list with the missing neighbor cell relation entry, using the first cell-specific information.

4. Method according to claim 3, the method further comprising the step of
sending, from the first network node to the second network node, second cell-specific information technically characterizing the first cell, the second cell-specific information permitting updating the second neighbor cell list with the missing neighbor cell relation entry,

5. Network node configured for updating neighbor cell information in a radio communications system comprising at least one Radio Access Technology network, the network node controlling a cell, said radio communications system further comprising a mobile terminal, a further network node controlling a further cell, the further network node broadcasting a first neighbor cell list, and the network node broadcasting a second neighbor cell list,
the network node comprising
receiving means configured for receiving, from the mobile terminal, an indicator, with the indicator indicating a missing neighbor cell relation entry in the first neighbor cell list, the neighbor cell relation entry representing a neighbor cell relation between the cell and the further cell;
sending means configured for sending, to the further network node, a cell identifier, the cell identifier uniquely identifying the cell, and first cell-specific information technically characterizing the cell, the first cell-specific information permitting updating the first neighbor cell list with the missing neighbor cell relation entry.

6. Network node according to claim 5, the network node further comprising
second receiving means, configured for receiving, from the further network node, second cell-specific information technically characterizing the further cell, the second cell-specific information permitting updating the second neighbor cell list with the missing neighbor cell relation entry; and
updating means configured for updating the second neighbor cell list with the missing neighbor cell relation entry, using the second cell-specific information.

7. Network node configured for updating neighbor cell information in a radio communications system comprising at least one Radio Access Technology network, the network node controlling a first cell, said radio communications system comprising a mobile terminal, a second network node controlling a second cell, the network node broadcasting a first neighbor cell list, and the second network node broadcasting a second neighbor cell list, the network node comprising
receiving means configured for receiving, from the second network node, a cell identifier, the cell identifier uniquely identifying the second cell, and first cell-specific information technically characterizing the second cell, the first cell-specific information permitting updating the first neighbor cell list with a missing neighbor cell relation entry in the first neighbor cell list, the neighbor cell relation entry representing a neighbor cell relation between the first cell and the second cell; and
updating means configured for updating the first neighbor cell list with the missing neighbor cell relation entry, using the first cell-specific information.

8. Network node according to claim 7, the network node further comprising sending means configured for sending, to the second network node, second cell-specific information technically characterizing the first cell, the second cell-specific information permitting updating the second neighbor cell list with the missing neighbor cell relation entry.

9. Method according to claim 1, wherein the first network node and the second network node are part of the same Radio Network Subsystem of a Radio Access Technology network.

10. Method according to claim 1, wherein the first network node is part of a first Radio Access Technology network with a first Radio Access Technology, and the second network node is part of a second Radio Access Technology network with a second Radio Access Technology, said first and second Radio Access Technologies being different.

11. Method according to claim 10, wherein the first Radio Access Technology is UTRAN and the second Radio Access Technology is GERAN, or wherein first Radio Access Technology is GERAN and the second Radio Access Technology is UTRAN.

12. Method according to claim 10, wherein the first Radio Access Technology is UTRAN and the second Radio Access Technology is E-UTRAN, or wherein the first Radio Access Technology is E-UTRAN and the second Radio Access Technology is UTRAN.
